(19) United States
(12) Patent Application Publication
(10) Pub. No.: US 2025/0196607 A1
(43) Pub. Date: Jun. 19, 2025

(54) VEHICLE MOUNTING STRUCTURE FOR BATTERY PACK AND METHOD FOR MANUFACTURING THE SAME

(71) Applicants: Shigeyuki INOUE, Toyota-shi (JP); Yasuhiro SEKIYA, Shibuya-ku (JP)

(72) Inventors: Shigeyuki INOUE, Toyota-shi (JP); Yasuhiro SEKIYA, Shibuya-ku (JP)

(73) Assignees: TOYOTA JIDOSHA KABUSHIKI KAISHA, Toyota-shi (JP); SUBARU CORPORATION, Tokyo (JP)

(21) Appl. No.: 18/944,797

(22) Filed: Nov. 12, 2024

(30) Foreign Application Priority Data
Dec. 13, 2023 (JP) 2023-210311

(51) Int. Cl. B60K 1/04; H01M 50/204; H01M 50/242; H01M 50/249; H01M 50/262

(52) U.S. Cl. CPC B60K 1/04; H01M 50/204; H01M 50/242; H01M 50/249; H01M 50/262; B60K 2001/0438; H01M 2220/20

(57) ABSTRACT

A vehicle mounting structure for a battery pack and a method for manufacturing the same which can reduce deterioration of the motion performance of a vehicle even when a common energy absorption material member is employed is provided. A vehicle mounting structure for a battery pack including a battery stack includes: a pair of energy absorption material members extending in a front-rear direction of a vehicle so that the energy absorption material members sandwich an outer side of the battery pack in a vehicle width direction and being longer than the battery pack in the front-rear direction of the vehicle; and a cross member extending in the vehicle width direction, ends of the cross member being connected to corresponding ends of the energy absorption material members.

### CROSS REFERENCE TO RELATED APPLICATIONS

This application is based upon and claims the benefit of priority from Japanese patent application No. 2023-210311, filed on Dec. 13, 2023, the disclosure of which is incorporated herein in its entirety by reference.

### BACKGROUND

The present disclosure relates to a vehicle mounting structure for a battery pack for mounting the battery pack on a vehicle and a method for manufacturing the same.

A vehicle mounting structure for a battery pack including a pair of energy absorption material members extending in the front-rear direction of a vehicle so that they sandwich the outer side of the battery pack in the vehicle width direction is known (see, for example, Japanese Unexamined Patent Application Publication No. 2023-046719).

### SUMMARY

Incidentally, energy absorption material members on the sides of a battery pack are attached to the rockers of the underbody of a vehicle. The presence of the battery pack between the rockers as mentioned above improves rigidity of the rocker with regard to the relative twisting in the rolling direction. That is, the body and the battery pack are engaged in the rolling direction and the rigidity is thus improved, whereby the motion performance of the vehicle is improved.

Meanwhile, for example, it is assumed that the common energy absorption material member employed for battery packs having different battery capacities is a common energy absorption material member in order to reduce costs. In this case, the length of the energy absorption material member in the front-rear direction of the vehicle is determined in accordance with the battery pack having the largest size. Therefore, the energy absorption material member may protrude further forward and rearward of the vehicle than the battery pack does. As a result, the rigidity with regard to the relative twisting in the roll direction described above may be reduced, and thus the motion performance of the vehicle may be deteriorated.

The present disclosure has been made in order to solve the above-described problem and a main object thereof is to provide a vehicle mounting structure for a battery pack and a method for manufacturing the same which can reduce deterioration of the motion performance of a vehicle even when a common energy absorption material member is employed.

In order to achieve the above-described object, one aspect according to the present disclosure is a vehicle mounting structure for a battery pack including a battery stack, the vehicle mounting structure including:
a pair of energy absorption material members extending in a front-rear direction of a vehicle so that the energy absorption material members sandwich an outer side of the battery pack in a vehicle width direction and being longer than the battery pack in the front-rear direction of the vehicle; and
a cross member extending in the vehicle width direction, ends of the cross member being connected to corresponding ends of the energy absorption material members.

In the above aspect, a cross-sectional shape of each of the ends of the cross member may be a U-shape that is opened outward in the vehicle width direction, and the ends of the energy absorption material members may fit into corresponding openings of the ends of the cross member.

In the above aspect, the ends of the energy absorption material members and the ends of the cross member may be fastened to each other by a fastening member that is longer than the length of the cross member in the vertical direction by a predetermined value or greater.

In order to achieve the above-described object, one aspect according to the present disclosure is a method for manufacturing a vehicle mounting structure for a battery pack including a battery stack, in which
a pair of energy absorption material members are arranged so that the energy absorption material members face in a front-rear direction of a vehicle and sandwich an outer side of the battery pack in a vehicle width direction, the energy absorption material members being longer than the battery pack in the front-rear direction of the vehicle, and
ends of a cross member extending in the vehicle width direction are connected to corresponding ends of the energy absorption material members.

According to the present disclosure, it is possible to provide a vehicle mounting structure for a battery pack and a method for manufacturing the same which can reduce deterioration of the motion performance of a vehicle even when a common energy absorption material member is employed.

The above and other objects, features and advantages of the present disclosure will become more fully understood from the detailed description given hereinbelow and the accompanying drawings.

### BRIEF DESCRIPTION OF DRAWINGS

FIG. 1 is a top view showing a vehicle mounting structure for a battery pack according to the present embodiment as seen from above;

FIG. 2 is a view showing a state of an energy absorption material member and a battery pack in the event of a side of a vehicle being hit in a collision; and

FIG. 3 is a cross-sectional view of a cross member when it is cut in the vertical direction along the line A-A shown in FIG. 1.

### DESCRIPTION OF EMBODIMENTS

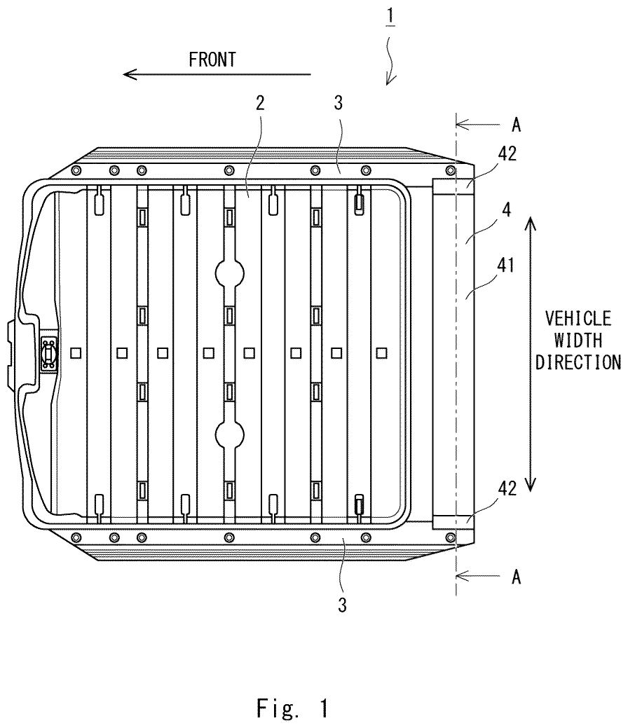

The present embodiment will be described hereinafter with reference to the drawings. FIG. 1 is a top view showing a vehicle mounting structure for a battery pack according to this embodiment as seen from above. A vehicle mounting structure 1 for a battery pack according to this embodiment includes a battery pack 2, a pair of energy absorption material members 3, and a cross member 4.

The battery pack 2 is mounted on a vehicle such as a hybrid electric vehicle, a plug-in hybrid electric vehicle, a fuel cell electric vehicle, and a battery electric vehicle. The vehicle mounting structure 1 for the battery pack 2 is provided, for example, below a floor panel and inside a frame member of the vehicle.

The battery pack 2 comprises, for example, a battery stack in which a plurality of battery cells are stacked in a case. The battery cell is composed of a lithium ion battery or the like.

The pair of Energy Absorption material members (EA material members) 3 are members for absorbing an impact from the sides of the vehicle. The pair of energy absorption material members 3 are provided inside the rockers of the underbody of the vehicle.

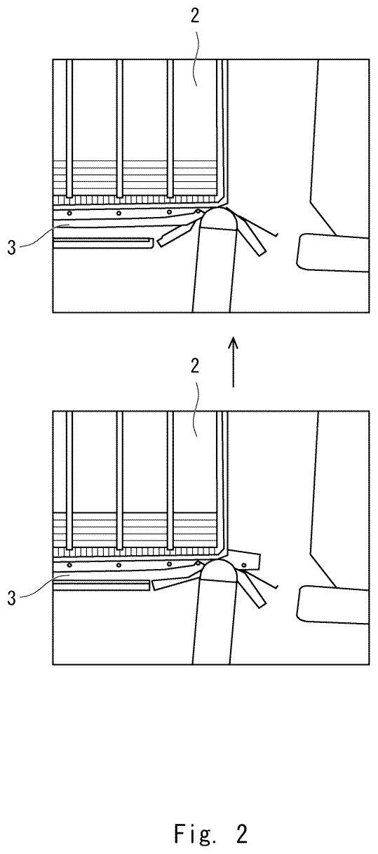

The pair of energy absorption material members 3 extend in the front-rear direction of the vehicle so that they sandwich the outer side of the battery pack 2 in the vehicle width direction. As a result, for example, as shown in FIG. 2, it is possible to appropriately protect the sides of the battery pack 2, in particular, the parts thereof having no battery frame or vehicle body frame, in the event of a side of the vehicle being hit in a collision (hereinafter referred to as a side collision of the vehicle).

The pair of energy absorption material members 3 are longer than the battery pack 2 in the front-rear direction of the vehicle. In this case, it is assumed that the common energy absorption material member 3 employed for the battery packs 2 having different battery capacities is a common energy absorption material member in order to reduce costs and improve expandability of mounting of it. In this case, the length of the energy absorption material member 3 in the front-rear direction of the vehicle is determined in accordance with the battery pack 2 having the largest size. Therefore, as described above, the energy absorption material member 3 is longer than the battery pack 2 in the front-rear direction of the vehicle, and thus may protrude further forward and rearward of the vehicle than the battery pack 2 does.

However, as described above, when the energy absorption material member protrudes further forward and rearward of the vehicle than the battery pack does, rigidity with regard to the relative twisting in the rolling direction of the vehicle may be reduced, and thus that the motion performance of the vehicle may be deteriorated.

On the contrary, as shown in FIG. 1, the vehicle mounting structure 1 for the battery pack 2 according to this embodiment includes the cross member 4 extending in the vehicle width direction, ends thereof being connected to corresponding ends of the energy absorption material members 3. By this cross member 4, rigidity with regard to the relative twisting in the rolling direction of the vehicle is improved, and deterioration of the motion performance of the vehicle can be reduced.

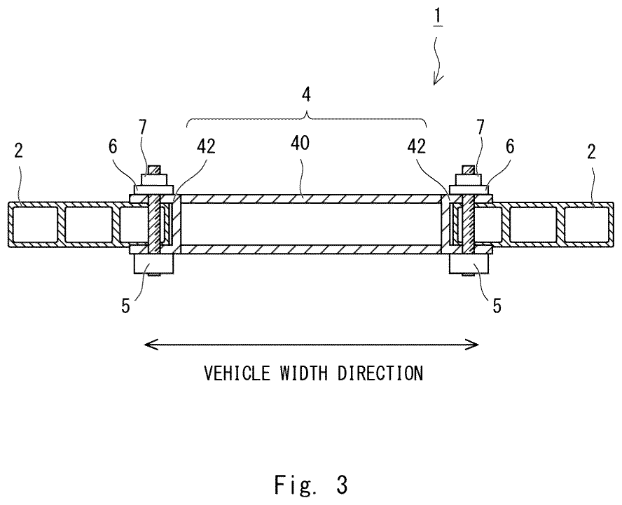

FIG. 3 is a cross-sectional view of the cross member 4 when it is cut in the vertical direction along the line A-A shown in FIG. 1. The cross member 4 is formed of, for example, a metal member having the second moment of area that can withstand a side collision load of 300 kN. The cross member 4 is formed of, for example, an iron-made 1180 material (a high-tensile steel plate) having a plate thickness of 2 mm or more. Thus, the cross member 4 may withstand the relative twisting in the rolling direction of the vehicle described above.

The cross member 4 is composed of a hollow brace member 41 extending in the vehicle width direction and a pair of patch members 42 connected to corresponding ends of the brace member 41. Although the ends of the brace member 41 and the pair of patch members 42 are connected to each other by welding or the like, the present disclosure is not limited thereto. The brace member 41 and the pair of patch members 42 may be integrally formed.

The cross section of the brace member 41 is formed in a square shape. As shown in FIG. 3, the cross-sectional shape of each of the patch members 42 at both ends of the brace member 41 is formed in a U-shape that is opened outward in the vehicle width direction. Rear ends of the energy absorption material members 3 are fitted into corresponding openings of the patch members 42. Thus, the manufacturing tolerance of the cross member 4 in the vehicle width direction can be absorbed.

For example, a bolt 5 penetrates the rear end of each of the energy absorption material members 3 and the patch member 42 of the cross member 4 in the vertical direction. By fastening a nut 7 through a washer 6 into the penetrating bolt 5, the rear end of each of the energy absorption material members 3 and the patch member 42 of the cross member 4 are fastened by the bolt 5 and the nut which are fastening members.

For example, it is assumed here that the energy absorption material member 3 is made of aluminum, and the case and the cross member 4 of the battery pack 2 are made of iron. In this case, a difference between the coefficient of linear expansion of the energy absorption material member 3 and the coefficient of linear expansion of the case and the cross member 4 of the battery pack 2 causes a displacement between these members, and thus it is necessary to absorb this displacement.

For example, when the bolts are arranged in the horizontal direction, a displacement due to the coefficient of linear expansion of about 1 mm occurs for a length of 1 m in the horizontal direction. Therefore, a structure for absorbing the displacement due to the coefficient of linear expansion described above is required.

On the contrary, in this embodiment, the length of the bolt 5 is longer than the length of the cross member 4 in the vertical direction by a predetermined value or greater. Thus, while the bolt 5 is being deformed, the above-described displacement due to the coefficient of linear expansion can be absorbed by the bolt 5 having a length of a predetermined value or greater. Such a predetermined value is, for example, about 1 to 2 mm, and the length of the predetermined value is a length by which it is possible to absorb the above-described displacement.

Next, the vehicle mounting structure 1 for the battery pack 2 and a method for manufacturing the same will be described. First, a pair of energy absorption material members 3, which are longer than the battery pack 2 is in the front-rear direction of the vehicle, are arranged so that they face in the front-rear direction of the vehicle and sandwich the outer side of the battery pack 2 in the vehicle width direction. Ends of the cross member 4 extending in the vehicle width direction are connected to corresponding rear ends of the energy absorption material members 3. Note that the battery pack 2 may be disposed between the pair of energy absorption material members 3 after the cross member 4 is connected to each of the energy absorption material members 3.

Several novel embodiments according to the present disclosure have been described above. However, these embodiments are merely presented as examples and are not intended to limit the scope of the disclosure. These novel embodiments can be implemented in various forms. Further, their components/structures may be omitted, replaced, or modified without departing from the scope and the spirit of the disclosure. These embodiments and modifications thereof are included in the scope and the spirit of the disclosure and also included in the disclosure specified in the claims and the scope equivalent thereto.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A vehicle mounting structure for a battery pack comprising a battery stack, the vehicle mounting structure comprising:
a pair of energy absorption material members extending in a front-rear direction of a vehicle so that the energy absorption material members sandwich an outer side of the battery pack in a vehicle width direction and being longer than the battery pack in the front-rear direction of the vehicle; and
a cross member extending in the vehicle width direction, ends of the cross member being connected to corresponding ends of the energy absorption material members.

2. The vehicle mounting structure according to claim 1, wherein a cross-sectional shape of each of the ends of the cross member is a U-shape that is opened outward in the vehicle width direction, and the ends of the energy absorption material members fit into corresponding openings of the ends of the cross member.

3. The vehicle mounting structure according to claim 2, wherein the ends of the energy absorption material members and the ends of the cross member are fastened to each other by a fastening member that is longer than the length of the cross member in the vertical direction by a predetermined value or greater.

4. A method for manufacturing a vehicle mounting structure for a battery pack comprising a battery stack, wherein
a pair of energy absorption material members are arranged so that the energy absorption material members face in a front-rear direction of a vehicle and sandwich an outer side of the battery pack in a vehicle width direction, the energy absorption material members being longer than the battery pack in the front-rear direction of the vehicle, and
ends of a cross member extending in the vehicle width direction are connected to corresponding ends of the energy absorption material members.
